(19) United States
(12) Patent Application Publication
(10) Pub. No.: US 2022/0084038 A1
(43) Pub. Date: Mar. 17, 2022

(54) SYSTEMS AND METHODS FOR FRICTIONLESS SELF-CHECKOUT MERCHANDISE PURCHASING

(71) Applicant: YUMMY FOODS, LLC, Los Angeles, CA (US)

(72) Inventor: Barnaby Montgomery, Pasadena, CA (US)

(21) Appl. No.: 17/483,642

(22) Filed: Sep. 23, 2021

Related U.S. Application Data
(63) Continuation of application No. 16/794,171, filed on Feb. 18, 2020, now abandoned.
Application No. 16/794,171 is a continuation of application No. 15/885,655, filed on Jan. 31, 2018, now abandoned.
Application No. 15/885,655 is a continuation of application No. 15/172,086, filed on Jun. 2, 2016, now abandoned.
(60) Provisional application No. 62/171,831, filed on Jun. 5, 2015.

(51) Int. Cl. G06Q 20/40; G06F 16/9535; G07G 1/00; G06Q 20/20; G06Q 20/32; G06Q 20/36

(52) U.S. Cl. CPC G06Q 20/4018; G06F 16/9535; G07G 1/0009; G06Q 20/36; G06Q 20/20; G06Q 20/208; G06Q 20/32; G07G 1/0081

(57) ABSTRACT

Systems, devices, and methods are provided for frictionless self-checkout for consumers in retail establishments.

### CROSS-REFERENCE TO RELATED APPLICATIONS

The present application is a continuation of U.S. patent application Ser. No. 16/794,171, filed Feb. 18, 2020, which is a continuation of U.S. patent application Ser. No. 15/885,655, filed Jan. 31, 2018, now abandoned, which is a continuation of U.S. patent application Ser. No. 15/172,086, filed Jun. 2, 2016, now abandoned, which claims priority to U.S. Provisional Patent Application No. 62/171,831, filed Jun. 5, 2015, the disclosures of which are hereby incorporated by reference in their entireties.

### FIELD

The subject matter described herein relates generally to systems and methods for frictionless self-checkout merchandise purchasing for consumers.

### BACKGROUND

Most retail stores employ cashiers to process transactions when consumers select products and purchase them. Typically, these cashiers are stationed at check stands near store exits. As any space not used in a retail store for displaying products can be wasted space which is not generating revenue, any additional check stands above a minimum required can cost stores revenue in the form of lost sales. When a store is busy lines can form at the individual check stands causing customers to waste time waiting for their individual turns to check out. This can be frustrating for customers and lead to reduced repeat business if the problems are severe enough. Self-checkout check stands have become increasingly popular in some retail stores where customers do not wish to interact with store clerks or where customers only have a few items and wish to check out quickly. These check stands can suffer from problems when customers are unfamiliar with their operation and have difficulty scanning products correctly.

Thus, needs exist for improved techniques by which consumers can save time and effort in checking out in retail establishments.

### SUMMARY

Provided herein are embodiments of systems and methods for consumer self-checkout of merchandise. In the modern world, most individuals carry a user mobile device such as a smartphone everywhere they go. These devices have incredible versatility and are useful in increasing convenience in many fields. As most user mobile devices include a camera, processors, memory, networking components and user interfaces, they can serve to replace check stands in stores and alleviate many of the issues described above. As such, they can increase time savings and convenience for customers, profitability for stores and also reduce the number of staff members required as cashiers. In some embodiments, customers can use standalone retail devices provided by stores in order to scan or key in item information and purchase items. These devices can include scanning, processing, networking and other functionality. The configuration of these systems is described in detail by way of various embodiments which are only examples.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is an example embodiment of a basic network setup diagram.

FIG. 1B is an example embodiment of a network connected server system diagram.

FIG. 1C is an example embodiment of a user mobile device diagram.

FIG. 1D is an example embodiment of a standalone retail device diagram.

FIG. 2 is an example embodiment of a system product identification and purchase diagram.

FIG. 3 is an example embodiment of an application use flow chart.

FIG. 4A is an example embodiment of a session creation flow chart.

FIG. 4B is an example embodiment of a session use flow chart

FIG. 4C is an example embodiment of a session confirmation and payment flow chart.

FIG. 5 is an example embodiment of a user interface product listing screen.

FIG. 6 is an example embodiment of a user interface session creation screen.

FIG. 7 is an example embodiment of a user interface account identification screen.

FIG. 8 is an example embodiment of a user interface product scanning screen.

FIG. 9 is an example embodiment of a user interface order viewing screen.

FIG. 10 is an example embodiment of a user interface purchase screen.

FIG. 11 is an example embodiment of a user interface home screen.

FIG. 12 is an example embodiment of a user interface login screen.

FIG. 13 is an example embodiment of a user interface account creation screen.

FIG. 14 is an example embodiment of a user interface user agreement screen.

FIG. 15 is an example embodiment of a user interface account creation information screen.

FIG. 16 is an example embodiment of a user interface introduction screen.

FIG. 17 is an example embodiment of a user interface profile image creation screen.

FIG. 18 is an example embodiment of a user interface payment selection screen.

FIG. 19 is an example embodiment of a user interface payment source entry screen.

FIG. 20 is an example embodiment of a user interface CVV confirmation screen.

FIG. 21 is an example embodiment of a user interface product image capture screen.

FIG. 22 is an example embodiment of a user interface captured image selection screen.

FIG. 23 is an example embodiment of a user interface captured image selection screen.

FIG. 24 is an example embodiment of a user interface review current order screen.

FIG. 25 is an example embodiment of a user interface review current order totaling screen.

FIG. 26 is an example embodiment of a user interface current order summary screen.

FIG. 27 is an example embodiment of a user interface current order processing screen.

FIG. 28 is an example embodiment of a user interface current order incomplete notification screen.

FIG. 29 is an example embodiment of a user interface current order complete confirmation notification screen.

FIG. 30 is an example of a user interface Pending Images review screen.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers, power components and other equipment and devices as appropriate to implement the methods and systems described herein are contemplated.

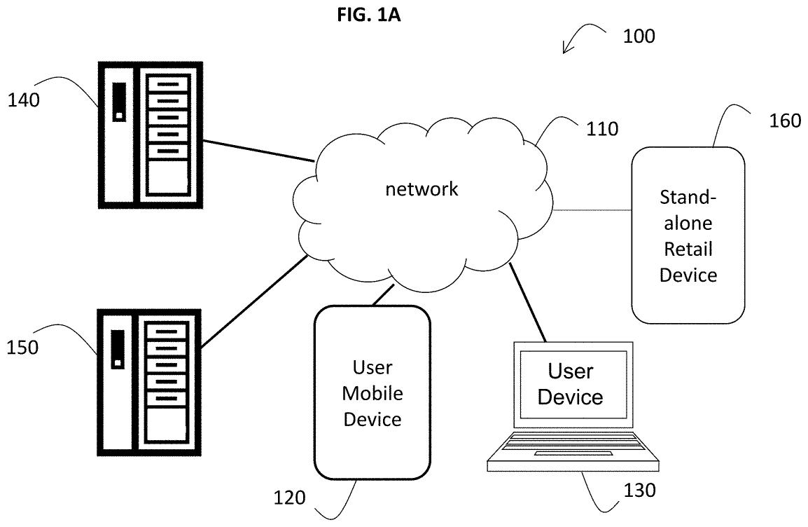

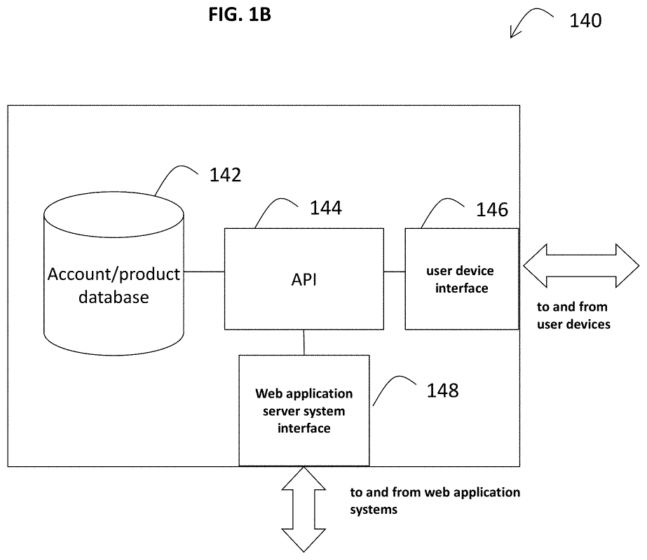

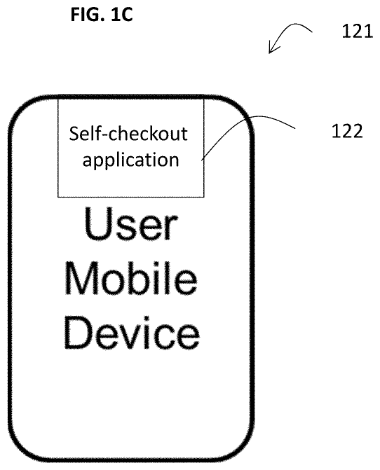

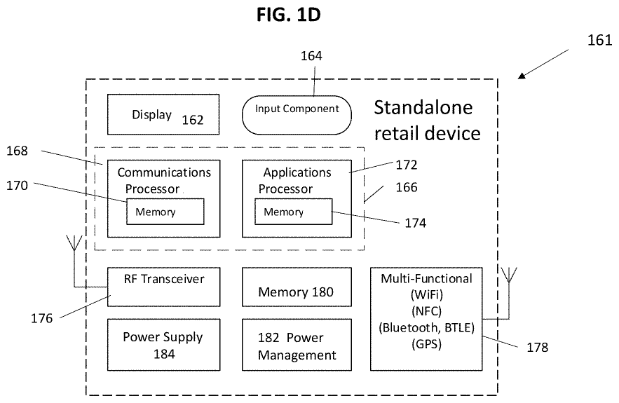

FIG. 1A is an example embodiment of a basic network setup diagram 100. As shown in the example embodiment, network setup diagram 100 of can include multiple servers 140, 150 which can include applications distributed on one or more physical servers, each having one or more processors, memory banks, operating systems, input/output interfaces, power supplies, network interfaces, and other components and modules implemented in hardware, software or combinations thereof as are known in the art. These can be communicatively coupled with a network 110 such as a public network (e.g. the Internet and/or a cellular-based wireless network, or other network) or a private network. Servers 140, 150 can be operable to interface with websites, webpages, web applications, social media platforms, advertising platforms, and others. As shown, a plurality of end user devices 120, 130 can also be coupled to the network and can include, for example: user mobile devices such as phones, tablets, phablets, handheld video game consoles, media players, laptops; wearable devices such as smartwatches, smart bracelets, smart glasses or others; and user devices such as desktop devices or other devices with computing capability and network interfaces and operable to communicatively couple with network 110. Also shown is an example embodiment of a standalone retail device 160 which can be a device particular to an industry, store, chain of stores, company or the like that is specifically purposed for use with particular products and includes all, some or no other functionality other than with particular systems and methods as described herein.

FIG. 1B is an example embodiment of a network connected server system diagram 140. As shown in the example embodiment, a server system can include at least one user device interface 146 implemented with technology known in the art for facilitating communication between user devices and a server based and communicatively coupled application program interface (API) 144. API 144 of the server system can also be communicatively coupled to at least one web application server system interface 148 for communication with web applications, websites, webpages, websites, social media platforms, and others. API 144 can also be communicatively coupled with a server based account, product or combination database 142, other databases implemented in non-transitory computer readable storage media and other interfaces. API 144 can instruct database 142 to store (and retrieve from the database) information such as product information, user account information, associated account information, or others as appropriate. Database 142 can be implemented with technology known in the art, such as relational databases, object oriented databases, combinations thereof or others. Database 142 can be a distributed database and individual modules or types of data in the database can be separated virtually or physically in various embodiments.

FIG. 1C is an example embodiment of a user mobile device diagram 121. As shown in the example embodiment, a user mobile device, such as user mobile device 120 of FIG. 1A, can includes a network connected self-checkout application 122 that is installed in, pushed to, or downloaded to the user mobile device. In many embodiments user devices are touch screen devices such as smart phones, phablets or tablets which have at least one processor, network interface, camera, power source, memory, speaker, microphone, input/output interfaces, operating systems and other typical components and functionality implemented and coupled to create a functional device, as is known in the art.

FIG. 1D is an example embodiment of a standalone retail device diagram 161. As shown in the example embodiment, a standalone retail device such as standalone retail device 160 of FIG. 1A can include networking interfaces which can include wired and wireless interfaces 176, 178. Wireless interfaces 176, 178 can be used to send signals for retailers to track movement of consumers through the store in order to analyze consumer flow paths or movements through the store as well as to communicate with networks such as the Internet or in-store networks maintaining local databases of current inventory in non-transitory computer readable storage media. They can also be used for improved customer service, where a consumer can select a customer service option which alerts a store employee to assist the consumer at her location. Wireless communications can occur using single type RF transceivers 176, multi-functional transceivers 178 providing access to Wi-Fi, NFC, Bluetooth, BTLE, GPS and other single or multi-functional transceivers.

Also included can be a user interface for consumers to interact with the device in the form of an input component 164. This can include buttons or a touchscreen device and other input components. A display 162 for showing the consumer advertisements, inventory and other information; at least one processor bank 166 for executing application operations using an applications process 172 and an associated memory 174; at least one communications processor 168 for executing communications operations and an associated memory 174; memory 180 for storing other information; an operating system (not shown); a power supply 184 such as at least one rechargeable battery; power management component(s) 182; an audio input, output or combination device (not shown) to receive audible instructions from a consumer or inform a consumer that a scan has been performed, respectively and visual scanning components (not shown) such as a camera which can capture an image and digital signal processing to interpret the captured image. All components are operably electronically and communicatively coupled such as is known in the art as to operate as a functional device for providing functions as described herein.

In practice, a consumer can enter a store and conveniently located nearby or in other strategic locations and select a standalone retail device to use while in the store, such as standalone retail device 160 of FIG. 1A and including at least some of the plurality of components depicted in standalone retail device diagram 161 of FIG. 1D as would be known to provide operable functionality. In some embodiments the consumer may be required to swipe a credit card at a terminal in order to use the device, in order to protect from theft or damage to the device. The consumer can then use the device to scan items, look up items, view advertisements, call for assistance, and perform other functions before completing a transaction. Then when preparing to leave the store, a receipt can be displayed or printed at a network connected printer and shown to a loss prevention employee if required.

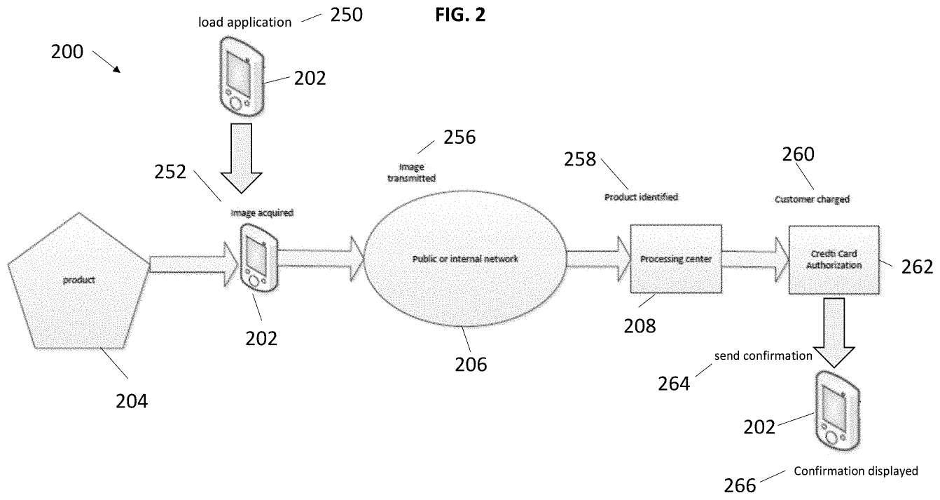

FIG. 2 is an example embodiment of a system product identification and purchase diagram 200. In an example embodiment, a consumer can download a self-checkout application to a user mobile device 202 and register an account including payment information and a self-identification image prior to or after entering a retail store or other establishment. If downloaded at home or other remote location, the consumer can load a self-checkout application either at their location or in a retail store in step 250 on user mobile device 202, by selecting an application icon on a user interface of the user mobile device, using a fingerprint identification, inputting a keystroke identifier or other authentication process. They can also select the name of the store they have entered or plan to enter. Next, the consumer can select a start shopping button on the application or choose to view their account. The consumer can use the user mobile device operation to input a self-identification image and in some embodiments this can be used to check the consumer in at the store and can be uploaded to a store monitoring system which can track which consumers are in the store or currently shopping over the network.

When shopping in the physical store or from home or another remote location, a camera of the user mobile device 202 can be used to acquire an image (also called “scanning” herein) of a desired product 204 for purchase using a camera component of the user mobile device in step 252. In some embodiments the image can be an image of product packaging, product name, UPC, SKU, nutritional label, ingredient list, or other identifying information. In some embodiments, the system can also be used for products that do not have standardized product packaging, such as retail clothing stores. In some embodiments, the system can also display lists of products ordered by category, brand or in other logical fashion and have search functionality for consumers to find products to purchase. The consumer can then select a quantity of products of the particular scanned or selected product.

Next, in step 256 the acquired image of the desired product can be transmitted over a public or private network 206 to a processing center 208. Processing center 208 can include servers, databases and can be automated or semi-automated with human oversight capabilities using monitors. Processing center 208 can run one or more image recognition software programs and check images against an image database to determine whether the image represents a product which is represented by data stored in the database. If the image is determined to match data in the database, it is identified in step 258 then the customer can be charged for the product in step 260. After credit card authorization is processed in step 262, a confirmation message can be sent to the user mobile device 202 in step 264 and displayed in step 266 to inform the customer that the purchase was successful. Alternately (not shown), if the image represents a product which is not represented by data stored in the database or some other identification error occurs, the processing center can transmit a message for display at the user device to seek help from a store employee such as a customer service specialist or alert customer service representatives directly. In some embodiments, intermediate steps can send a confirmation message to the consumer asking to confirm if the product identified in the database is correct and if they wish to purchase the identified product. In some embodiments, the steps of FIG. 2 can be performed at a customer's home or other remote location. In such embodiments, additional steps can include store employees or distribution center employees receiving the order from the server, gathering the items included in the order for the customer and preparing them for the user to pick up. In other embodiments the gathered items can be shipped or otherwise delivered to the customer at their home or a location of their choosing by system administrator owned vehicles or third party delivery services.

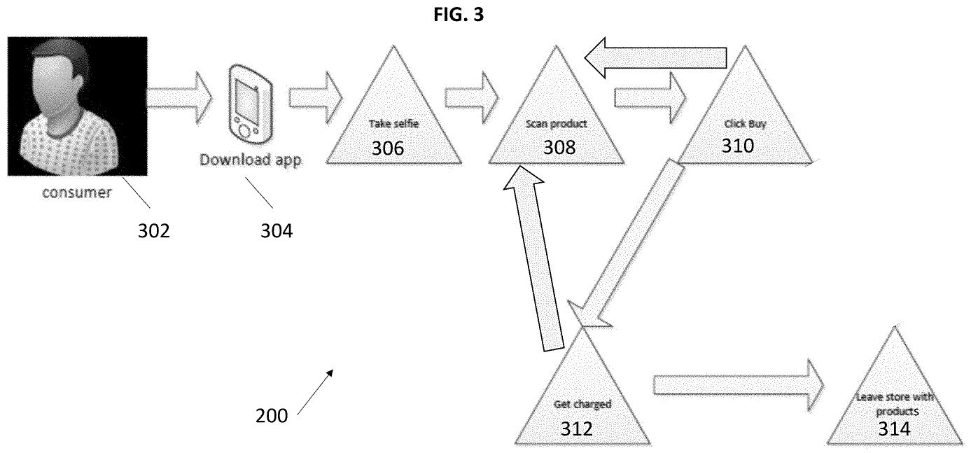

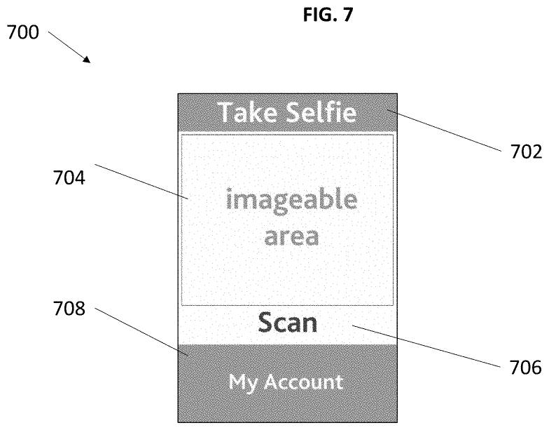

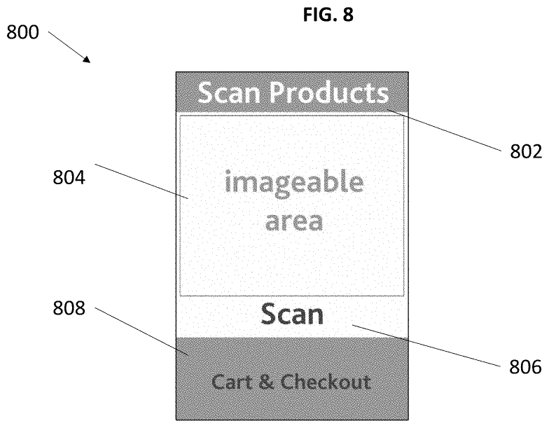

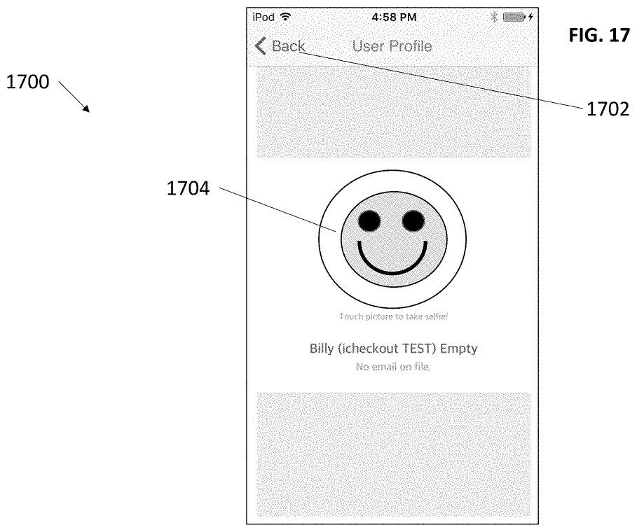

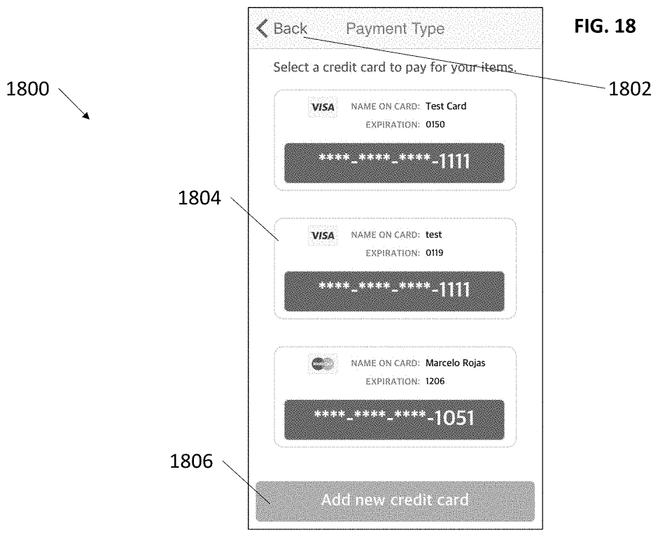

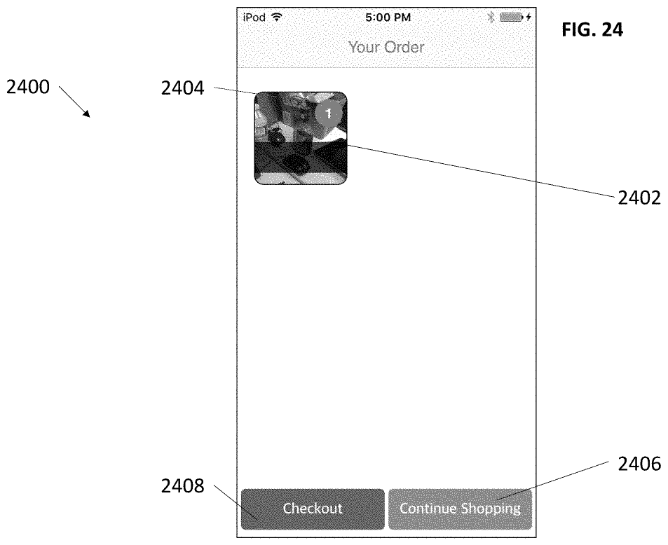

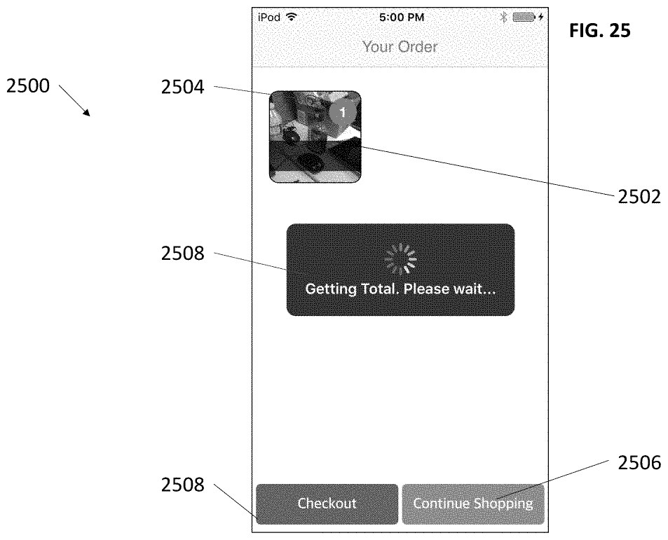

FIG. 3 is an example embodiment of an application use flow chart 300. As shown in the example embodiment, a consumer 302 can download a self-checkout application on their user mobile device in step 304, either at a remote location or in-store. The user can create an account including a username; password; confirmation questions; credit card, debit card, bank transfer, virtual currency or other payment information, as described elsewhere herein (see FIGS. 18-20 and associated descriptions); and a capture a reference image “selfie” in step 306 (see FIG. 7 and FIG. 17 and associated description) using a camera of the user device. The consumer can then scan a product in step 308 (see FIGS. 8 and 21-23 and associated descriptions) as described above and select a “buy” option in step 310 if the product is identified, for instance by checking a local or remote database. Once the consumer has selected a buy option in step 310, the customer can be charged for the item in step 312 and can either continue shopping by scanning additional products in step 308 or leave the store with the products in step 314. In various embodiments, multiple charges can be consolidated into a single payment from the consumer to the store. Alternatively, once the customer has selected a buy option in step 310 the item can be added to a current basket list of products (see FIG. 24 and associated description) and the consumer can be directed back to a scan product screen. Then, once the consumer has decided that they are finished shopping, the consumer can select a complete order option and be charged in step 312 (see FIGS. 25-29 and associated descriptions) before leaving the store in step 314.

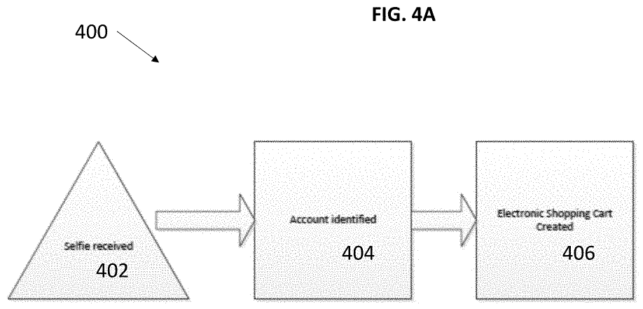

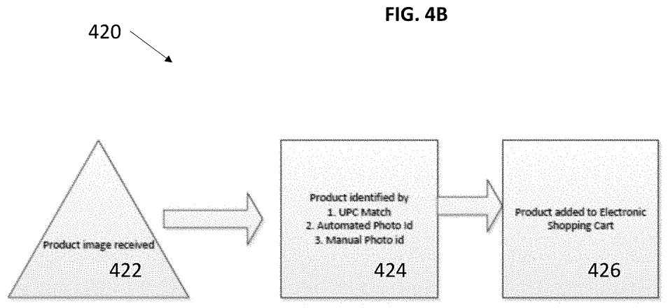

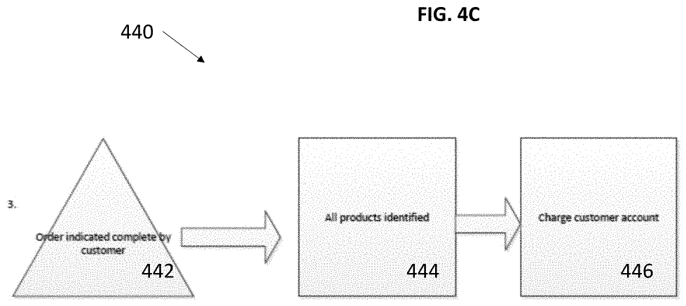

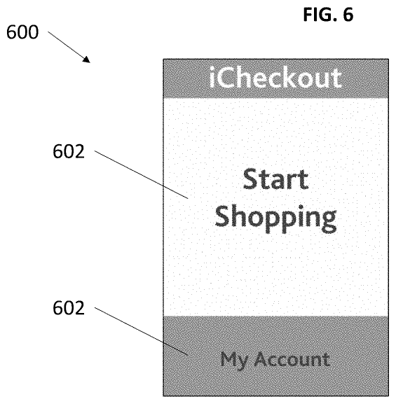

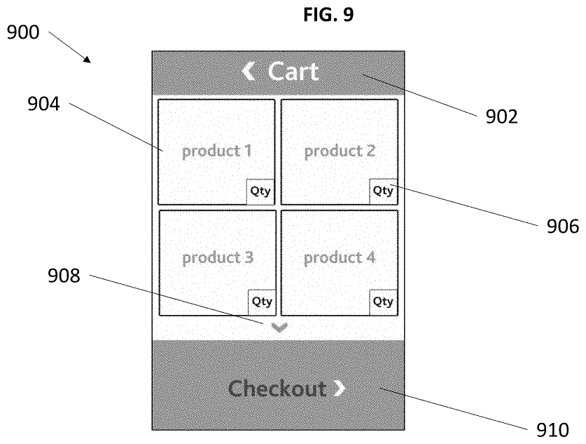

FIG. 4A is an example embodiment of a session creation flow chart 400. As shown in the example embodiment, the consumer has previously set up an account. Before or upon arriving at a retail store, a consumer can initiate a session creation process which allows the consumer to use a self-checkout application on a user device without having to interact with a store check-out employee or stand in line. This can include loading the self-checkout application “start shopping” screen as shown and described with respect to FIG. 6. The consumer can first capture an image of their own face using a camera of the device, or take a “selfie” in step 402, which can be compared against a database of images or a local image stored in memory using image recognition processes, as shown and described further with respect to FIG. 7. When the user account is matched or otherwise identified to an account in step 404, an electronic shopping cart can be created in step 406 in the application and displayed for the consumer, as shown and described further with respect to FIG. 9. In some embodiments this can include showing a favorites list for the user, displaying a preset shopping list, displaying advertisements, delivering messages to the user from the store or other functions.

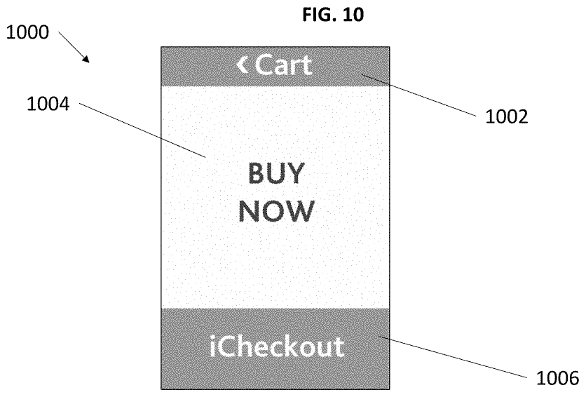

FIG. 4B is an example embodiment of a session use flow chart 420. In the example embodiment a consumer can use the user mobile device's camera to capture an image of the item or product in step 420 and described further with respect to FIG. 8. The image can be processed using various functionality to identify and extract important or relevant information to identify the product in step 424. For example, magnification, clarification, blur reduction, color adjustment, lighting adjustment, angle recognition, image mapping, and various other image manipulation and processing functionality can be used to compare a captured image with images in a database. The captured image can then be identified by matching UPC numbers, SKU numbers, automatic matching, consumer manual name input, speech recognition confirmation or other techniques. After this step, the product can be added to the electronic shopping cart in step 426, where a user can view a list of names, images, quantities or other identifiers of products currently in the shopping cart as shown and described further with respect to FIG. 9. Alternatively or additionally, the system can allow the consumer a chance to confirm that the identified product is the one they wish to purchase using a confirmation screen as shown and described further with respect to FIG. 10. In some embodiments, product recommendations can be given based on products the consumer has placed in the shopping cart. For example, if the consumer has added hamburgers to the electronic shopping cart then the system can recommend hamburger buns, ketchup, mustard, charcoal, lettuce, tomatoes, cola, or other associated or frequently purchased together products may be displayed to remind the consumer of other products they may have forgotten to purchase. Also, in some embodiments users can rate and comment on products and view ratings and comments from other users.

In some embodiments a first step could be replaced by voice recognition functionality of the user device where a user says a product name and quantity into a microphone of the user device, the application or central system can analyze the speech and compares it against a database, and then display a matching product and quantity or error message if no match is found.

In some embodiments the system can recommend better value products, on sale products, healthier products, complementary products, products with similar nutrition profiles or manufacturer recommended products based on a particular identified product. For example, if a user captures an image of a name brand cottage cheese, the system can have a trigger which recommends a generic or store brand cottage cheese which is a better value based on a best price algorithm executed by a processor that checks against all other similar products in the store inventory, with the option to remove the name brand cottage cheese from the electronic shopping cart.

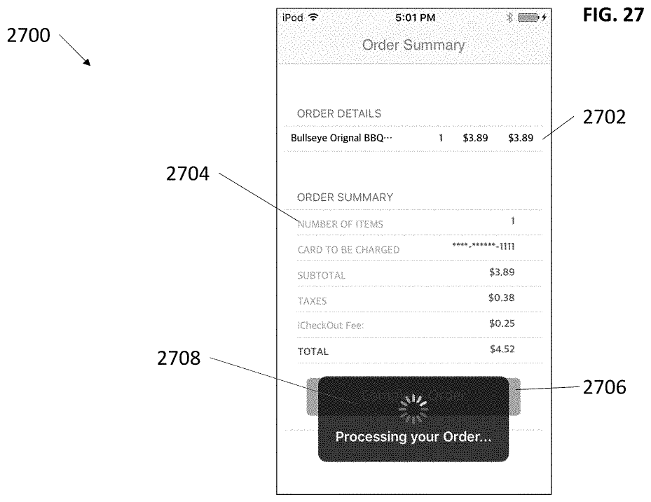

FIG. 4C is an example embodiment of a session confirmation and payment flow chart 440. As shown in the example embodiment, a customer can indicate that an order is complete in step 442 and be shown an order confirmation screen (see FIGS. 9 and 24-26). The order confirmation screen can include a listing of names, quantities, prices and other pertinent information for all items in the current session. The consumer can double check that all items are in the list in step 444 and once satisfied, the consumer can select a charge customer account or checkout button. Then, in step 446, the customer account can be charged. After this point, an order receipt screen can be displayed for the consumer to review or to show to staff at the store, for example, when the customer is leaving the store (see FIG. 27 and associated description).

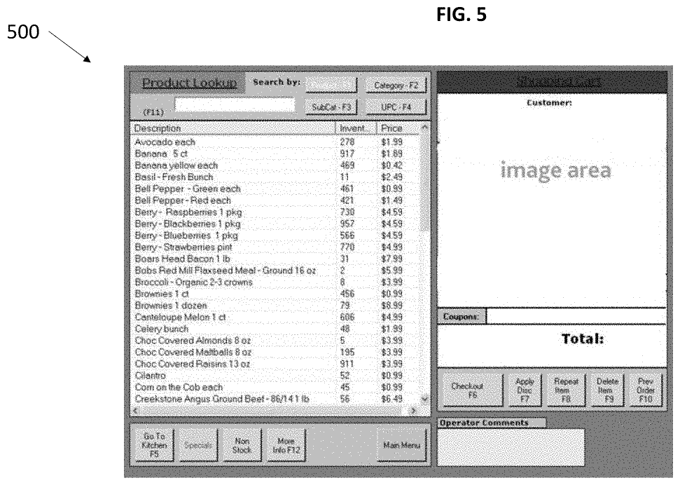

FIG. 5 is an example embodiment of a user interface product listing screen 500. As shown in the example embodiment, a consumer can manually look up items for purchase. Information displayed by the system can include a product description, such as “Avocado each,” an inventory amount, “278,” indicating how many of the product are currently in the store, and a price per product, “$1.99.” Consumers can scroll through a full store inventory or search the inventory using various search functions including product name, product category, product subcategory, UPC, related items, new stock items and others.

In various embodiments, the system can be integrated with home appliances such as a refrigerator, freezer, pantry, closet or others which track items in a consumer's home. As such, the system can display a precise inventory of an individual's stock of items available at their home. Other pertinent data included can include upcoming expiration dates, recent purchases, grocery or other shopping lists, upcoming holiday or other calendar events, notes from other household members, special requests, recipes and other information. This precise inventory with other pertinent data can be viewed by the consumer when at a retail establishment by selecting an appropriate home inventory button. In the example embodiment this is shown as a “Go to Kitchen” button.

A “Specials” button can display weekly specials, monthly specials, current holiday sales, manufacturer specials, distributor specials, retailer specials, frequent buyer specials, or others for the current retail establishment. A non-stock button can display items that are currently out of stock and can suggest other locations where the item is in stock. A more info button can display additional information for a selected item including nutritional information for food; product size accessories, clothing or footwear; product dimensions for furniture, appliances or electronics; battery or other required additional components for electronics, toys, or others.

A “Shopping cart” area of the screen can display an image of the item which the consumer can compare with the item they are examining in the store. Additionally, a consumer can apply coupons by capturing an image of them or selecting them from a list stored in a database. A “Repeat item” button can allow a consumer to increase a quantity of an item without having to capture additional images of the item. A “Delete item” button can allow a consumer to delete the item from the current shopping cart. A “Preview order” button can allow a consumer to view a listing or images of all items currently in the shopping cart as well as a current total including tax and coupons applied.

FIG. 6 is an example embodiment of a user interface session creation screen 600. As shown in the example embodiment, a consumer can load a self-checkout application on a user device and be presented with the user interface session creation screen 600 on a display of the user device. The user can then begin a new session by selecting a “Start Shopping” button 602 or view account details such as payment method (see FIG. 18 and associated description), address, name, preferences, or other details by selecting a “My Account” button 604.

FIG. 7 is an example embodiment of a user interface account identification screen 700. As shown in the example embodiment, a consumer can capture an image of themselves through the self-checkout application by viewing an imaging portion of the application, indicated by a “Take Selfie” header area 702. When a user facing camera is facing the user and an acceptable image of the user is displayed in an imageable area 704, the user can select a “Scan” button 706 to capture the image. If a consumer selects a “My Account” button 708, they can view their last selfie, download images from local or remote memory, change credit card billing addresses, change mobile telephone numbers, update credit card information on file (which also needs to be updated a specific number of days before it is set to expire) and update a fingerprint identification or keystroke identification process.

FIG. 8 is an example embodiment of a user interface product scanning screen 800. As shown in the example embodiment, a “Scan Products” header 802 indicates that a user consumer can scan products using a camera through the self-checkout application by directing the view of the camera toward a product. Then the product will be viewable in the imageable area 804. The consumer can then select a “Scan” button 806 to capture an image. The consumer can select a “Cart and Checkout” button 808 to view items currently in the electronic shopping cart and to pay for the items (see FIG. 9 and associated description).

FIG. 9 is an example embodiment of a user interface order viewing screen 900. As shown in the example embodiment, a consumer can view images 904 of the products they have chosen as well as quantities 906 for each of the products. In some embodiments, prices can also be shown, as well as a total order price. Consumers can scroll down by selecting a down button 908 or up using an up button (not shown). The consumer can then checkout by selecting the “Checkout” button 910 (see FIG. 10 and associated description) or return to a cart by selecting a “Cart” button 902 (see FIG. 8 and associated description).

FIG. 10 is an example embodiment of a user interface purchase screen 1000. As shown in the example embodiment, the consumer can select a “Buy Now” button 1004 to confirm a purchase or select a “Cart” button 1002 to go back and review a product list where the consumer can edit or delete products from the cart (see FIG. 8 and associated description). If the electronic shopping cart includes regulated products such as alcohol or tobacco the application can require authorization from a store attendant. In some embodiments the system can notify store employees that regulated products have been selected. An application name can be displayed in a footer field 1006 or a header field.

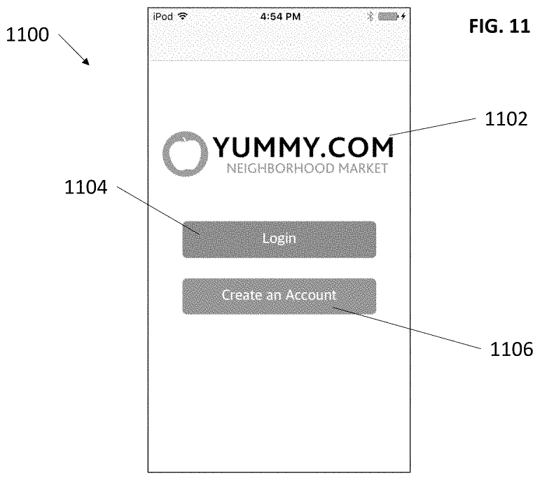

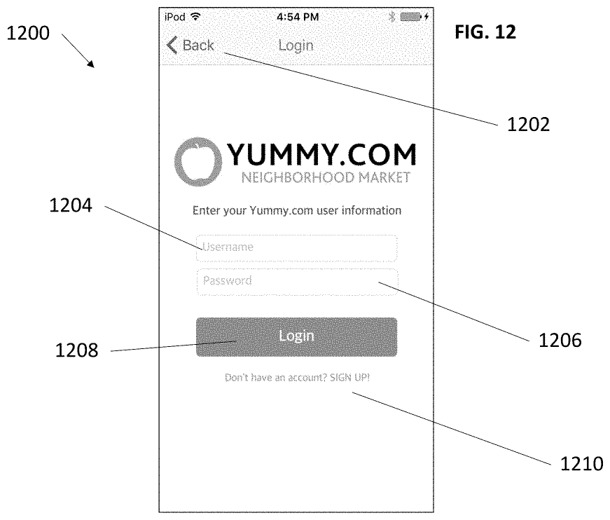

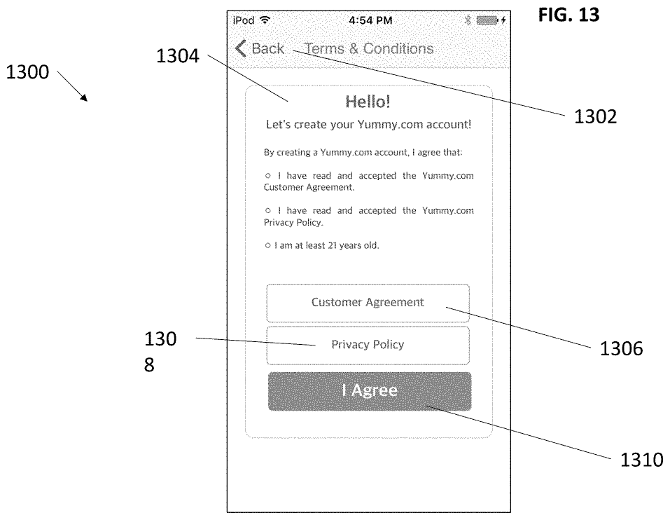

FIG. 11 is an example embodiment of a user interface home screen 1100. As shown in the example embodiment, a user can view an application name field 1102 showing the name of the application. In the example this is “YUMMY.COM NEIGHBORHOOD MARKET.” A user can select a “Login” button 1104 if they already have an account (see FIG. 12 and associated description) or a “Create an Account” button 1106 if they do not have an account but wish to create one (see FIG. 13 and associated description).

FIG. 12 is an example embodiment of a user interface login screen 1200. As shown in the example embodiment, a user can navigate to a previous screen by selecting a “Back” button 1202. Otherwise, a user can enter a system username in a “Username” field 1204 and a system password in a “Password field 1206 before selecting a “Login” button that will check the entered credentials before accepting or denying the user access to the system. If the user does not have an account yet, they can create one by selecting a “SIGN UP!” button. This can take them to a user account creation screen, as shown in FIG. 13.

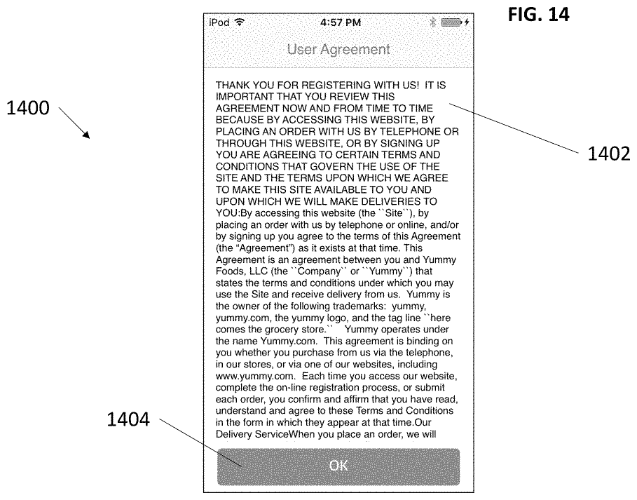

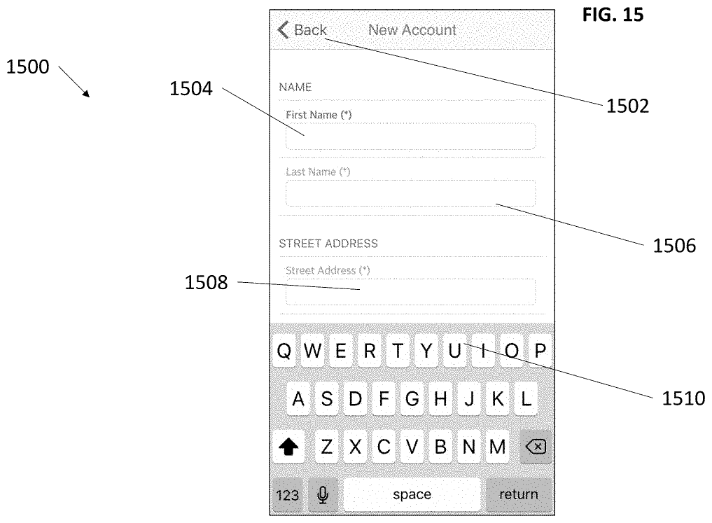

FIG. 13 is an example embodiment of a user interface account creation screen 1300. As shown in the example embodiment, a user can navigate to a previous screen by selecting a “Back” button 1302. Terms and Conditions of account creation can be described in an instruction field 1304. In the example embodiment, these read: “Hello! Let's create your Yummy.com account! By creating a Yummy.com account, I agree that: I have read and accepted the Yummy.com Customer agreement. I have read and accepted the Yummy.com Privacy Policy. I am at least 21 years old.” A user can review a customer agreement by selecting a “Customer Agreement” button 1306 that can take them to a user or customer agreement screen, as shown in FIG. 14. The user can review a privacy policy by selecting a “Privacy Policy” button 1308 which will display this respective information. A user can then select an “I Agree” button 1310 to move forward to a user interface account creation information screen, as shown in FIG. 15.

FIG. 14 is an example embodiment of a user interface user agreement screen 1400. As shown in the example embodiment, a user can review a customer or user agreement which can be displayed in a scrollable field 1402. If the user agrees, they can select an “OK” button 1404 that can take them back to an account creation screen, as shown in FIG. 13.

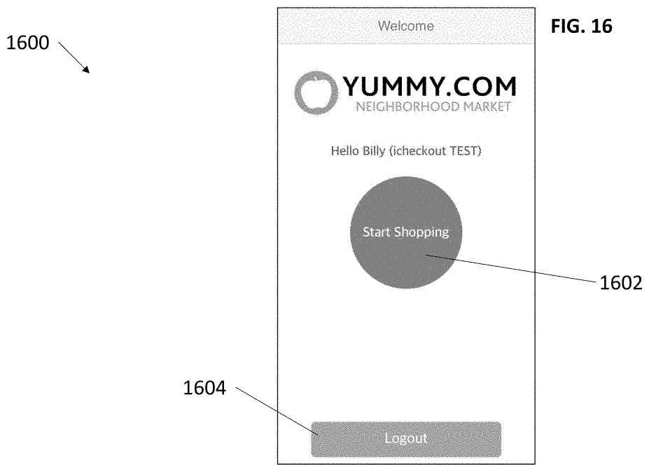

FIG. 15 is an example embodiment of a user interface account creation information screen 1500. As shown in the example embodiment, a user can navigate to a previous screen by selecting a “Back” button 1502. Users can enter personal information when creating an account such as a first name in first name field 1504, a last name in last name field 1506, an address in address field 1508 and others such as email address, phone numbers and others using a keypad 1510. Once finished they can be shown an introduction screen, as shown in FIG. 16.

FIG. 16 is an example embodiment of a user interface introduction screen 1600. As shown in the example embodiment, the user can begin a shopping experience by selecting a “Start Shopping” button 1602 (see FIG. 17 and associated description). A user can log out of the application using a “Logout” button 1604.

FIG. 17 is an example embodiment of a user interface profile image creation screen. As shown in the example embodiment, a user can navigate to a previous screen by selecting a “Back” button 1702. A consumer can create a user profile by capturing an image of themselves through the self-checkout application. When a user facing camera is facing the user and an acceptable image of the user is displayed in an imageable area 1704, the user can select a tap or select the image in order to capture the image. This can then be checked for authorization using an image recognition algorithm executed by a processor of the user device.

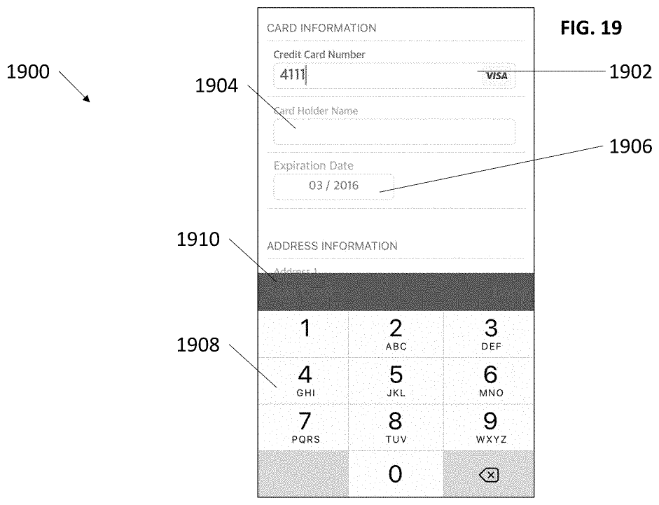

FIG. 18 is an example embodiment of a user interface payment selection screen. As shown in the example embodiment, a user can navigate to a previous screen by selecting a “Back” button 1802. A consumer user can enter new payment information, such as credit or debit card information into the application by selecting an “Add new credit card” button 1806 (see FIG. 19 and associated description) and can view and select various saved payment information details in payment information selection fields 1804 in order to choose an appropriate payment method.

FIG. 19 is an example embodiment of a user interface payment source entry screen 1900. As shown in the example embodiment, add a credit card number in Credit Card Number field 1902, a name associated with the card in Card Holder Name field 1904, an expiration date in Expiration Date field 1906 and billing address in one or more address fields (not shown) manually using a keypad 1908. Users can also capture credit card information using a camera or other scanner of the user device by selecting a “Scan Card” button 1910.

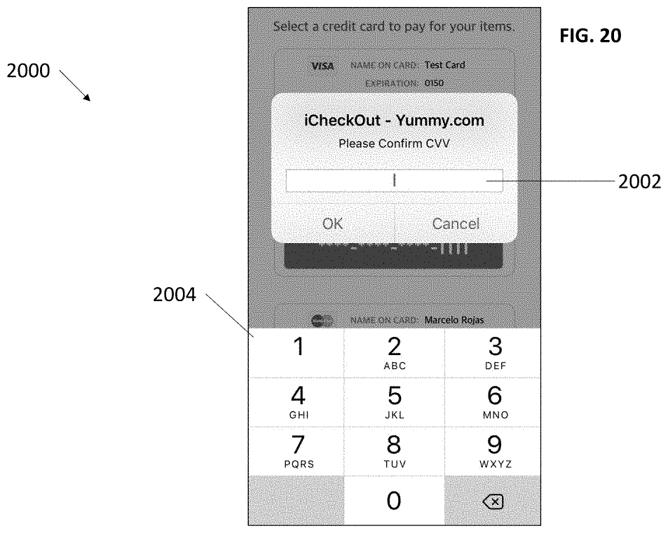

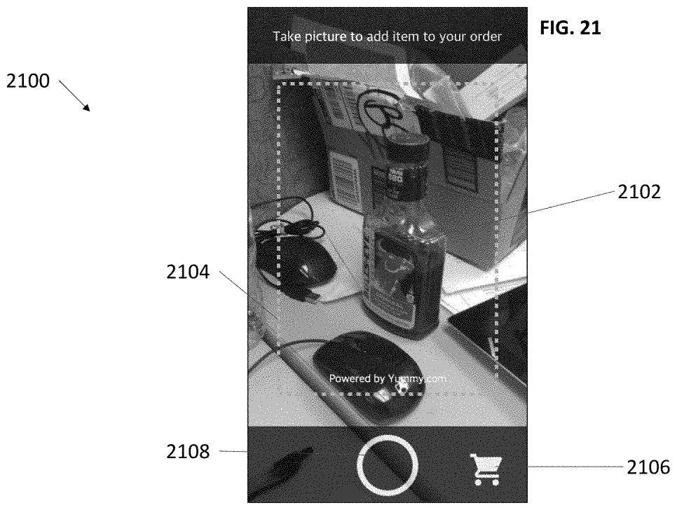

FIG. 20 is an example embodiment of a user interface CVV confirmation screen 2000. As shown in the example embodiment, a user can confirm a credit card CVV number by entering it into a “Please Confirm CVV” field 2002 using a keypad 2004. This can help to ensure that the user is an authorized user of the payment method. Payment information can be checked locally with stored data in non-transitory memory of the user device or transmitted over a network to a remote server with payment information stored in non-transitory memory for confirmation using an automated algorithm executed by a processor. Once an authorized payment method has been confirmed by the user, they can begin shopping using the application, for instance by being directed to a product image capture screen as shown in FIG. 21.

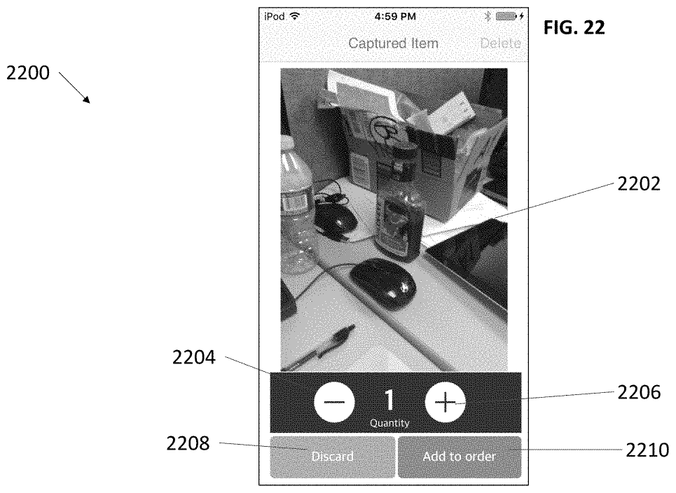

FIG. 21 is an example embodiment of a user interface product image capture screen 2100. As shown in the example embodiment, a user can aim a camera of the user device at a product 2102 that they wish to purchase to ensure it is within a capture window 2104. Once the user decides to capture the image, they can select a capture image button 2108 and then be shown a captured image selection screen, as shown in FIG. 22. The user can also view a current cart by selecting cart button 2106, as shown in FIG. 24.

FIG. 22 is an example embodiment of a user interface captured image selection screen 2200. As shown in the example embodiment, a user can view the image of the product 2202 and increase or decrease a quantity of items using a subtract button 2204 or add button 2206. Users can also choose to discard the image and product from their order by selecting a discard button 2208. Additionally, users can confirm the quantity and product by selecting an add to order button 2210. Once added to the order, a user can be shown a current order screen, as shown in FIG. 24.

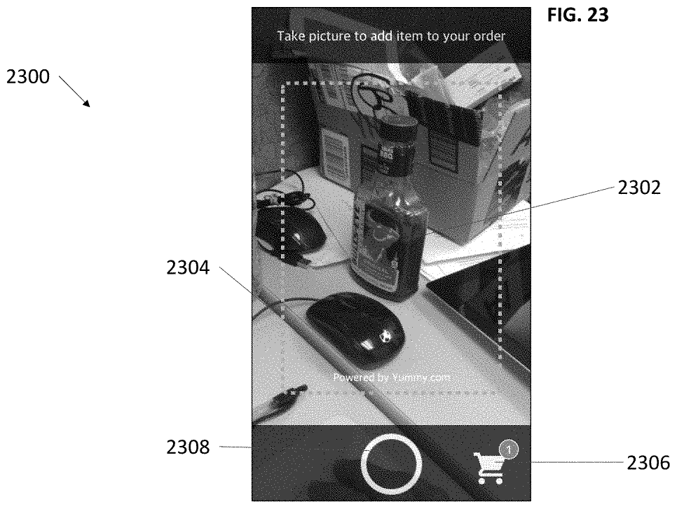

FIG. 23 is an example embodiment of a user interface captured image selection screen 2300. As shown in the example embodiment, a user can capture another product 2302 or the same product in window 2304 using capture button 2308. A cart with a number of current items is shown as selectable cart icon 2306, which can take the user to a current order screen as shown in FIG. 24.

FIG. 24 is an example embodiment of a user interface review current order screen 2400. As shown in the example embodiment, a user can view images 2402 of products they have captured as well as quantities 2404 of the products they selected. They can choose to continue shopping by selecting a “Continue Shopping” button 2406 (see FIG. 23 and associated description) or choose to end the current session and purchase the products by selecting a “Checkout” button 2408 (see FIG. 25 and associated description). In some embodiments, users can begin an order in a remote location, such as their home, before completing the order by adding additional items in a retail store. These incomplete orders can be stored in non-transitory memory and recalled by the application for use in the future.

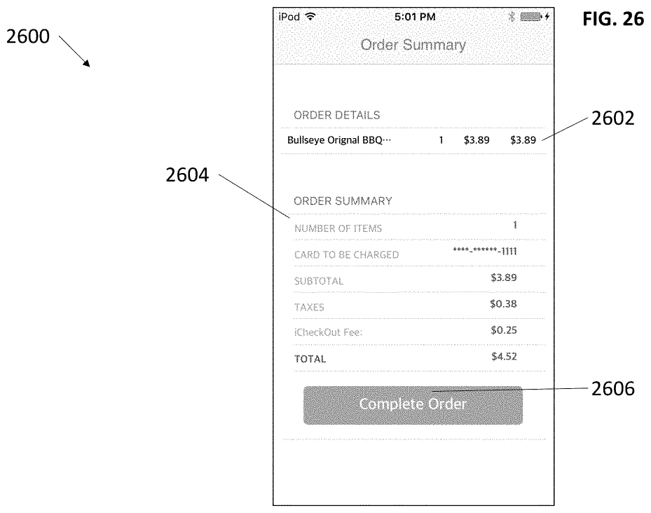

FIG. 25 is an example embodiment of a user interface review current order totaling screen 2500. As shown in the example embodiment, element numbers with corresponding equivalents of those in FIG. 24 provide similar functionality while a totaling processing icon 2510 indicates that the total price of the order is being processed by the system. Once processed, the user interface can display a current order summary screen, as shown in FIG. 26.

FIG. 26 is an example embodiment of a user interface current order summary screen 2600. As shown in the example embodiment, a user can view order details such as product name, quantity, individual price and total quantity price in an order details area 2602. Users can view an order summary including a number of items in the order, a card or other payment method to be charged, a subtotal, taxes, system use fee and grand total in an order summary total 2604. Users can them complete the order by selecting a complete order button 2606 (see FIG. 27 and associated description). In many embodiments, various options can be changed by either selecting them and updating appropriate information or by selecting a back button or a cart button, neither of which are shown in FIG. 26.

FIG. 27 is an example embodiment of a user interface current order processing screen 2700. As shown in the example embodiment, element numbers with corresponding equivalents of those in FIG. 26 provide similar functionality while an order processing icon 2608 indicates that the order is being processed by the system.

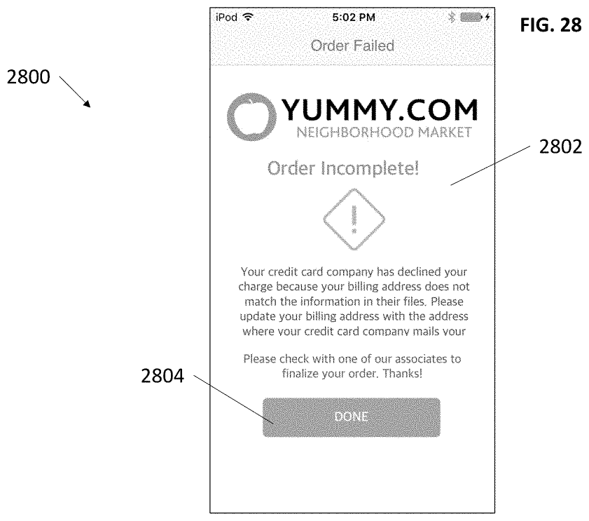

FIG. 28 is an example embodiment of a user interface current order incomplete notification screen 2800. As shown in the example embodiment, a user can be notified of an incomplete or otherwise deficient order including information 2802 about what the problem with the order is. This may occur if the order is declined by the system for a particular reason or reasons such as billing, lack of in-store inventory or other problems. In the example embodiment, the notification reads: “Order Incomplete! Your credit card company has declined your charge because your billing address does not match the information in their files. Please update your billing address with the address where your credit card company mails your statement. Please check with one of our associates to finalize your order. Thanks!” The user can then select an acknowledgement button, here in the form of a “Done” button 2804 that can take them back to a current order summary screen, as shown in FIG. 27.

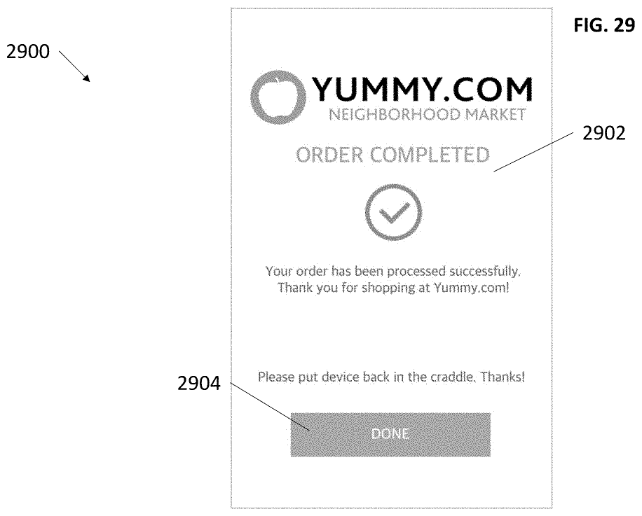

FIG. 29 is an example embodiment of a user interface current order complete confirmation notification screen 2900. As shown in the example embodiment, an alternative to the user interface current order incomplete notification screen shown in FIG. 28, provides information 2902 about a completed order. Here the information 2902 reads: “Order Completed Your order has been processed successfully. Thank you for shopping at Yummy.com! Please put device back in the cradle. Thanks!” The user can then select an acknowledgement button, here in the form of a “Done” button 2904. When a user is ready to leave the store, they may display an electronic receipt on the user interface to a store employee who can confirm the items in the order. In some embodiments, the electronic receipt can be transmitted to a network connected printer via the network in order to print a hard copy of the receipt for the user, the store or both.

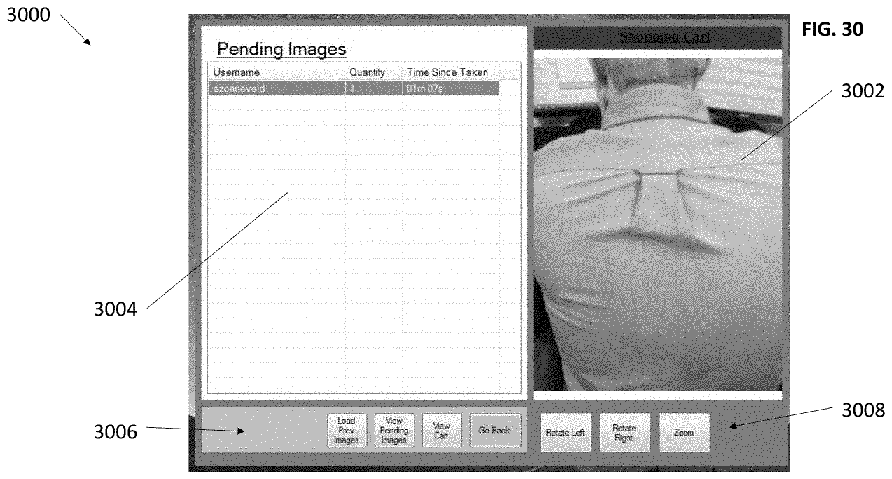

FIG. 30 is an example of a user interface Pending Images review screen 3000. In the example embodiment, a system administrator can view a listing 3004 of pending images including the username who took the image, a quantity of items for the image and when the image was captured. This can be useful for administrators to review customer orders in store, to provide improved customer service assistance and help prevent theft. Images can be viewed in an image panel 3002 and interacted with using various buttons 3008, such as: rotate left, rotate right, zoom and others. Administrators can view individual user information by using user interaction buttons 3006, such as: load previous images, view pending images, view cart, go back and others. In some embodiments, this can also display user images for the administer, in order to visually confirm the identity of the user and the order.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A method for providing customer self-checkout using a network connected mobile device and server, comprising:
the mobile device, having a processor and associated non-transitory computer readable memory with stored instructions that, when executed by the processor, cause the mobile device to:
create or access a system account stored in non-transitory computer readable memory for a user of an application including:
a linked payment account stored in non-transitory computer readable memory;
a self-portrait of the user captured using a camera of the mobile device and stored in non-transitory computer readable memory; and
when the user loads the application in a store, capture a user selected self-portrait when beginning a shopping session using the camera of the mobile device;
capture a user selected product image using the camera of the mobile device;
transmit the captured product image via the network for comparison by the server with a database of products stored in non-transitory computer readable memory using image processing executed by a processor of the server;
if the product is found in the database of products, receive product information associated with the product from the server via the network;
add the captured product image with associated product information to an electronic shopping cart stored in non-transitory computer readable memory; and
transmit purchase information to the server via the network, causing the server processor to charge the linked payment account upon a user-selected purchase option.

2. The method of claim 1, further comprising:
the mobile device selectively displaying a searchable product listing.

3. The method of claim 1, further comprising:
the mobile device selectively displaying a listing of the home inventory items previously purchased by the user.

4. The method of claim 1, further comprising:
the mobile device selectively displaying an order receipt upon completion of the order by the user.

5. The method of claim 1, further comprising:
the mobile device storing an incomplete order that the user created at a remote location before entering the store and selectively displaying the incomplete order to the user in the store.

6. The method of claim 1, further comprising:
the mobile device requiring a user to confirm a CVV code of a payment source credit card to verify user authorization of the credit card.

7. The method of claim 1, further comprising:
the mobile device selectively displaying a user-modifiable quantity of individual items for an order.

8. A system for providing customer self-checkout comprising:
a network connected server, comprising:
a product database stored in non-transitory computer readable memory; and
a processor;
a network connected mobile device, comprising:
a camera;
a processor; and
non-transitory computer readable memory storing instructions that, when executed by the mobile device processor, cause the mobile device to:
create or access a system account for a user of a shopping application stored in non-transitory computer readable memory including:
a linked payment account stored in non-transitory computer readable memory;
a self-portrait of the user captured using a camera of the mobile device and stored in non-transitory computer readable memory;
selectively load the application in a store and capture a user selected self-portrait using the camera when beginning a shopping session;
selectively capture a product image using the camera;
transmit the captured product image via the network for comparison by the server with the product database using image processing;
if the product is found in the product database, receive product information associated with the product from the server via the network;
add the captured product image with the associated product information to an electronic shopping cart; and
upon a user-selected purchase option, transmit purchase information to the server via the network, causing the server to charge the linked payment account.

9. The system of claim 8, further comprising:
the mobile device selectively displaying a searchable product listing.

10. The system of claim 8, further comprising:
the mobile device selectively displaying a listing of the home inventory items previously purchased by the user.

11. The system of claim 8, further comprising:
the mobile device selectively displaying an order receipt upon completion of the order by the user.

12. The system of claim 8, further comprising:
the mobile device storing an incomplete order that the user created at a remote location before entering the store and selectively displaying the incomplete order to the user in the store.

13. The system of claim 8, further comprising:
the mobile device requiring a user to confirm a CVV code of a payment source credit card to verify user authorization of the credit card.

14. The system of claim 8, further comprising:
the mobile device selectively displaying a user-modifiable quantity of individual items for an order.

15. A network connected customer self-checkout device, comprising:
a camera;
a processor; and
non-transitory computer readable memory storing instructions that, when executed by the mobile device processor, cause the mobile device to:
create or access a system account for a user of an application including:
a linked payment account stored in non-transitory computer readable memory; and
a self-portrait of the user captured using a camera of the mobile device and stored in non-transitory computer readable memory;
selectively capture a user self-portrait using the camera when the user loads the application in a store and begins a shopping session;
selectively capture a user selected product image using the camera;
transmit the captured product image via the network to a server for comparison with a database of products stored in non-transitory computer readable memory using image processing, as executed by a server processor;
if the product is found in the database of products, receive product information associated with the product from the server via the network;
add the captured product image with associated product information to an electronic shopping cart in non-transitory computer readable memory; and
selectively transmit purchase information to the server via the network, causing the server to charge the linked payment account.

16. The device of claim 15, further comprising:
selectively displaying a searchable product listing.

17. The device of claim 15, further comprising:
selectively discarding items from an order.

18. The device of claim 15, further comprising:
selectively displaying an order receipt upon completion of the order by the user.

19. The device of claim 15, further comprising:
storing an incomplete order in non-transitory memory of a server that the user created at a remote location before entering the store and selectively retrieving and displaying the incomplete order to the user in the store upon the user logging in to the application.

20. The device of claim 15, further comprising:
requiring a user to confirm a CVV code of a payment source credit card to verify user authorization of the credit card.

21. The device of claim 15, further comprising:
selectively displaying a user-modifiable quantity of individual items for an order.
